(19) United States
(12) Patent Application Publication
(10) Pub. No.: US 2011/0187650 A1
(43) Pub. Date: Aug. 4, 2011

(54) KEYPAD APPARATUS

(75) Inventor: Yu-Sheop LEE, Suwon-si (KR)

(73) Assignee: Samsung Electronics Co., Ltd.

(21) Appl. No.: 13/017,763

(22) Filed: Jan. 31, 2011

(30) Foreign Application Priority Data
Jan. 29, 2010 (KR) 10-2010-0008752

(51) Int. Cl. G06F 3/02

(52) U.S. Cl. 345/170

(57) ABSTRACT

A key pad apparatus includes a key top part; an illuminating part for introducing the light of a light emitting element and diffusing the same; a first variable color display part to be irradiated by the diffused light from the illuminating part for selectively transforming its color to be reflected or transmitted according to an electrical signal; a first base film provided with a laminate under the first variable color display part and formed with a first printed surface; a second variable color display part provided with the laminate under the first base film to be irradiated by the diffused light from the illuminating part for selectively transforming its color to be reflected or transmitted according to an electrical signal; and a second base film provided with the laminate under the second variable color display part and formed with a first printed surface.

### PRIORITY

This application claims the priority under 35 U.S.C. §119(a) to an application entitled “Keypad Apparatus” filed in the Korean Intellectual Property Office on Jan. 29, 2010 and assigned Serial No. 10-2010-0008752, the contents of which are incorporated herein by reference.

### BACKGROUND OF THE INVENTION

1. Field of the Invention

The present invention relates generally to a keypad apparatus, and more particularly, to a keypad apparatus constructed by laminating a plurality of variable color display parts which selectively transform colors according to electrical signals and a plurality of base films provided with a plurality of printed surfaces, for example, characters, numerals and symbols.

2. Description of the Related Art

In general, a “portable communication device” refers to a device capable of performing wireless communication, while being carried by a user. Such a portable communication device includes an HHP, a CT-2 cellular phone, a digital phone, a PCS phone, a PDA or the like, which can be classified into various types depending on its appearance. For example, a wireless terminal is classified as a bar-type, a flip-type, a folder-type or a slide-type wireless terminal. The conventional portable terminals described above are necessarily provided with an antenna device, a data input/output device, and a data transmitting/receiving device. As a data input device, a keypad apparatus, in which data can be inputted mainly by a user's fingers, is commonly employed.

The keypad apparatus of the portable communication device is manufactured by printing or inscribing characters or numerals on a film or a plastic injection molded object to display the characters or numerals.

A keypad 10 manufactured in the form of a plastic injection molded object is shown in FIG. 1. The surface of the injection molded object is painted with a designated color. The characters or numerals 11 are obtained by exposing the painted surface by machining the same with a laser or the like. The surface exposed by inscription constitutes the characters or numerals.

However, in the keypad for the portable communication device described above, both the characters and numerals are provided on the exposed surface. Hence, if the characters and numerals are seen at the same time when the user desires to input only the characters, it has a limitation in that the user may be confused with the input operations and may therefore make errors in inputting the characters and numerals. In addition, since in the conventional keypad apparatus the characters and numerals cannot be overlappingly disposed in the same space, the font size of the characters and numerals cannot be increased. If the characters and numerals are formed in a bigger font size, it may serve as an obstacle to miniaturization of the portable communication device. Recently, as portable communication devices have become miniaturized, the size of the keypad has become smaller, so that the font size of the characters and/or numerals has also become smaller, which makes it inconvenient to use the keypad.

In order to solve the problems described above, a keypad apparatus using electronic paper has been developed.

The electronic paper is employed with technologies to display characters and numerals. As shown in FIGS. 2 and 3, a keypad apparatus 20 using the electronic paper is composed of a common electrode 26 disposed above an electronic ink layer 24, a segment electrode 22 disposed under the electronic ink layer 24, and a wiring 23 for providing an electrical signal to each electrode.

The electronic ink layer 24 includes a minute capsule having dyes, and the capsule displays colors when the dyes move in upward and downward directions within the capsule according to the electrical signal applied between the “positive (+)” and “negative (−)” electrodes.

For instance, when the positive voltage is applied, the electronic ink layer 24 is displayed in black, and when the negative voltage is applied, the electronic ink layer 24 is displayed in white. Therefore, in order to display the characters, numerals and symbols, the pattern of segments under the electronic ink layer should be correspondingly formed in the shapes of the characters, numerals and symbols.

However, since the keypad apparatus using the conventional electronic paper is designed to display the characters, numerals and symbols in a mono color, black or white, it has limited colors to display, thereby restricting the design of the keypad.

Further, since the conventional electronic paper has to drive a plurality of segments, it has further limitations in that the manufacturing cost for a segment circuit is increased, and components to drive the same therefore become complicated.

Moreover, the keypad apparatus using conventional electronic paper has limited ability to be used as a simple keypad in which one of the keys corresponds to each one of the characters, numerals and symbols to perform a corresponding order. Hence, it does not have a touch pad function to recognize writings in italic or to display inputted orders.

Therefore, there is a need to develop a keypad apparatus with a touch pad function, that is an elegantly designed product through the use of various color changes, that is easily usable, and reduces the number of segments of the electronic paper and the circuit components, thereby simplifying the assembling process of the product.

### SUMMARY OF THE INVENTION

Accordingly, the present invention has been made to solve the above-mentioned problems occurring in the prior art, and the present invention provides a keypad apparatus, wherein by laminating a plurality of base films provided with a plurality of variable color display parts which selectively transform colors according to electrical signals and a plurality of printed surfaces, for example, characters, numerals and symbols, it is possible to design elegant products using various color changes, so as to improve a user's convenience, and further reduce the number of components by removing the segments and circuit components necessary for the conventional electronic paper, thereby simplifying assembling processes and lowering production costs.

Also, the present invention provides a keypad apparatus, wherein by laminating a plurality of base films provided with a plurality of variable color display parts which selectively transform colors according to electrical signals and a plurality of printed surfaces, for example, characters, numerals and symbols, as well as by constructing a plurality of printed surfaces to be selectively displayed, it is possible to selectively use the plurality of the printed surfaces, and the selected printed surfaces can be transformed into various colors, thereby enhancing the user's convenience.

In addition, the present invention provides a keypad apparatus, wherein by laminating a plurality of base films provided with a plurality of variable color display parts, which selectively transform colors according to electrical signals and a plurality of printed surfaces, for example, characters, numerals and symbols, as well as by constructing a plurality of printed surfaces to overlap each other, it is possible to display the characters, numerals and symbols depending on a use mode by the user, so as to reduce the application area of the keypad and miniaturize the product itself accordingly, and apply the keypad to various types of wireless terminals, for example, a bar-type, a folder-type or a slide-type wireless terminal.

Further, the present invention provides a keypad apparatus, wherein by constructing it to be used as a touch pad depending on a use mode by the user, it is possible to input or display the characters, numerals and symbols using a stylus pen, thereby improving the usage of the product.

In accordance with an embodiment of the present invention, there is provided a keypad apparatus, including a key top part; an illuminating part for introducing light of a light emitting element and diffusing the light; a first variable color display part to be irradiated by the diffused light from the illuminating part for selectively transforming its color to be reflected or transmitted according to an electrical signal; a first base film provided with a laminate under the first variable color display part and formed with a first printed surface; a second variable color display part provided with the laminate under the first base film to be irradiated by the diffused light from the illuminating part for selectively transforming its color to be reflected or transmitted according to the electrical signal; and a second base film provided with the laminate under the second variable color display part and formed with a first printed surface.

In accordance with a further embodiment of the present invention, there is provided a keypad apparatus, including a key top part provided with a first printed surface to be displayed upon selection and a transparent color region; an illuminating part provided with a laminate under the key top part for introducing light of a light emitting element and diffusing the light; a first variable color display part to be irradiated by the diffused light from the illuminating part for selectively transforming its color to be reflected or transmitted according to an electrical signal; a first base film provided with the laminate under the first variable color display part and formed with a second printed surface to be displayed upon selection; a second variable color display part provided with the laminate under the first base film to be irradiated by the diffused light from the illuminating part for selectively transforming its color to be reflected or transmitted according to the electrical signal; and a second base film provided under the second variable color display part and formed with a third printed surface to be displayed upon selection.

In accordance with a further embodiment of the present invention, there is provided a keypad apparatus, including a key top part provided with a first printed surface which is formed in a transparent color with a background in black; an illuminating part provided with a laminate under the key top part for introducing light of a light emitting element and diffusing the light; a first variable color display part to be irradiated by the diffused light from the illuminating part for selectively transforming its color to be reflected or transmitted according to an electrical signal; a first base film provided with the laminate under the first variable color display part and formed with a second printed surface in black with a background in a transparent color which is overlappingly provided with the first and third printed surfaces; a second variable color display part provided with the laminate under the first base film to be irradiated by the diffused light from the illuminating part for selectively transforming its color to be reflected or transmitted according to the electrical signal; and a second base film provided with the laminate under the second variable color display part and formed with a third printed surface in black with a background in white which is overlappingly provided with the first and second printed surfaces.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects, features and advantages of the present invention will be more apparent from the following detailed description taken in conjunction with the accompanying drawings, in which:

FIG. 1 is a front view illustrating a conventional keypad apparatus;

FIG. 2 is a front view illustrating the conventional keypad apparatus using an electronic paper;

FIG. 3 is a side cross-sectional view illustrating the conventional keypad apparatus using the electronic paper;

FIG. 4 is an exploded perspective view illustrating constructions of a keypad apparatus in accordance with a first embodiment of the present invention;

FIG. 5 is a perspective view illustrating first and second variable color display parts of the keypad apparatus in accordance with the first embodiment of the present invention;

FIG. 6a is a front view illustrating a key top part of the keypad apparatus in accordance with the first embodiment of the present invention;

FIG. 6b is a front view illustrating a first base film of the keypad apparatus in accordance with the first embodiment of the present invention;

FIG. 6c is a front view illustrating a second base film of the keypad apparatus in accordance with the first embodiment of the present invention;

FIG. 7 illustrates a first operational example of the keypad apparatus in accordance with the first embodiment of the present invention;

FIG. 8 illustrates a second operational example of the keypad apparatus in accordance with the first embodiment of the present invention;

FIG. 9 illustrates a third operational example of the keypad apparatus in accordance with the first embodiment of the present invention;

FIG. 10 illustrates a fourth operational example of the keypad apparatus in accordance with the first embodiment of the present invention;

FIG. 11 is an exploded perspective view illustrating constructions of a keypad in accordance with a second embodiment of the present invention;

FIG. 12a is a front view illustrating a key top part of the keypad apparatus in accordance with the second embodiment of the present invention;

FIG. 12b is a front view illustrating a first base film of the keypad apparatus in accordance with the second embodiment of the present invention;

FIG. 12c is a front view illustrating a second base film of the keypad apparatus in accordance with the second embodiment of the present invention;

FIG. 13 illustrates a first operational example of the keypad apparatus in accordance with the second embodiment of the present invention;

FIG. 14 illustrates a second operational example of the keypad apparatus in accordance with the second embodiment of the present invention;

FIG. 15 illustrates a third operational example of the keypad apparatus in accordance with the second embodiment of the present invention;

FIG. 16 illustrates a fourth operational example of the keypad apparatus in accordance with the second embodiment of the present invention;

FIG. 17 is an exploded perspective view illustrating constructions of a keypad in accordance with a third embodiment of the present invention;

FIG. 18a is a front view illustrating a key top part of the keypad apparatus in accordance with the third embodiment of the present invention;

FIG. 18b is a front view illustrating a first base film of the keypad apparatus in accordance with the third embodiment of the present invention;

FIG. 18c is a front view illustrating a second base film of the keypad apparatus in accordance with the third embodiment of the present invention;

FIG. 19 illustrates a first operational example of the keypad apparatus in accordance with the third embodiment of the present invention;

FIG. 20 illustrates a second operational example of the keypad apparatus in accordance with the third embodiment of the present invention;

FIG. 21 illustrates a third operational example of the keypad apparatus in accordance with the third embodiment of the present invention;

FIG. 22 illustrates a fourth operational example of the keypad apparatus in accordance with the third embodiment of the present invention.

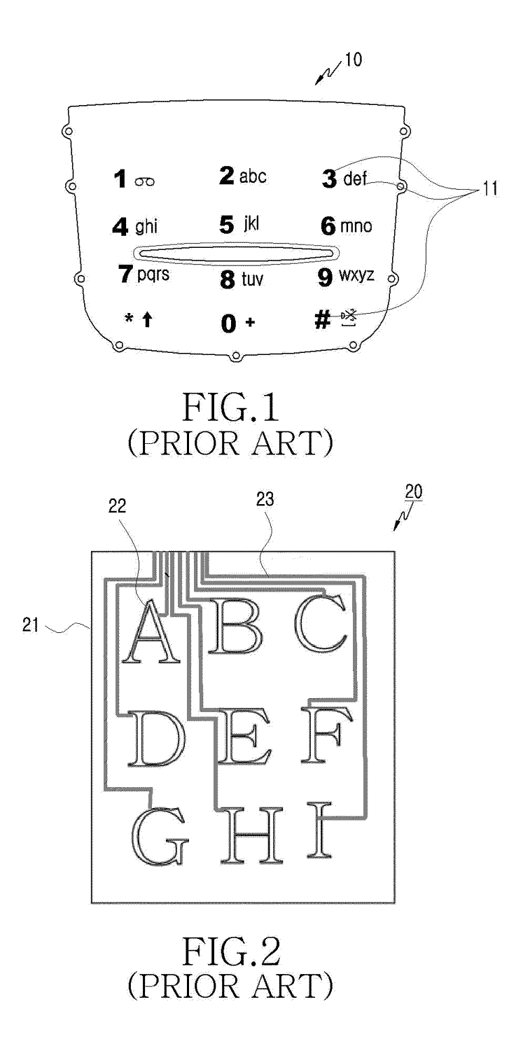

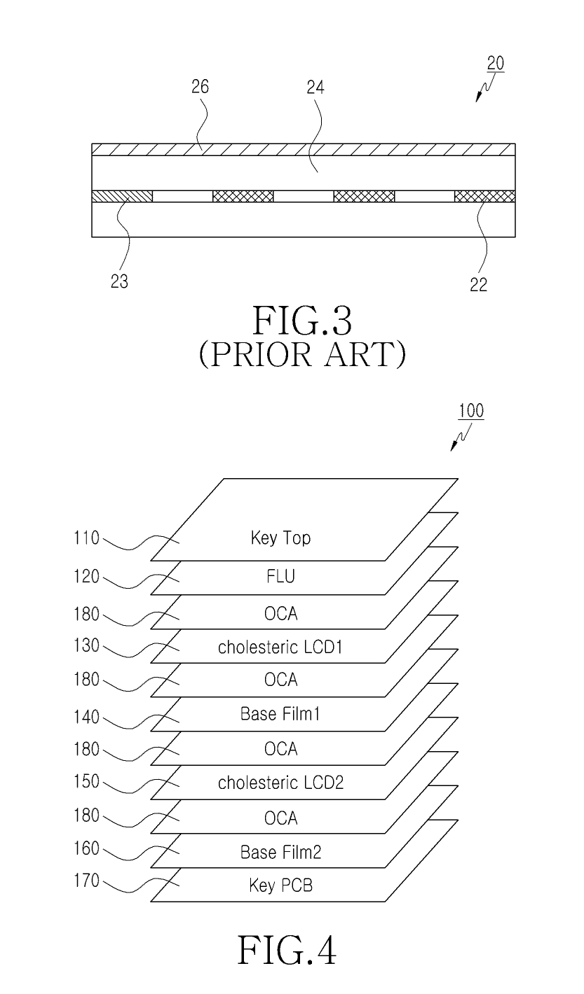

### DETAILED DESCRIPTION OF EMBODIMENTS OF THE PRESENT INVENTION

Hereinafter, embodiments of the present invention will be described with reference to the accompanying drawings. In the following description, the same elements will be designated by the same reference numerals although they are shown in different drawings. Further, various specific definitions found in the following description, such as specific values of packet identifications, contents of displayed information, etc., are provided only to help general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention unclear.

Referring to FIGS. 4 to 10, a keypad apparatus 100 of the present invention includes a key top part 110, an illuminating part 120 or a Front Light Unit (FLU), first and second variable color display parts 130 and 150, and first and second base films 140 and 160 formed with first and second printed surfaces 141 and 161.

The key top part 110 is provided with a laminate above the illuminating part 120 to display the first and second printed surfaces 141 and 161 of the first and second base films 140 and 160 which are reflected or transmitted according to color transformations of the first and second variable color display parts 130 and 150 described below. The illuminating part 120 is provided with the laminate under the key top part 110 to introduce the light of a light emitting element (not shown) and to diffuse the same. The first variable color display part 130 is provided with the laminate under the illuminating part 120 and irradiated by the diffused light from the illuminating part 120 for selectively transforming its color to be reflected or transmitted according to an electrical signal. The first base film 140 is provided with the laminate under the first variable color display part 130 to reflect or transmit the light depending on the colors of the first and second variable color display parts 130 and 150. The second variable color display part 150 is provided with the laminate under the first base film 140 and irradiated by the diffused light from the illuminating part 120 for selectively transforming its color to be reflected or transmitted according to the electrical signal. The second base film 160 is provided with the laminate under the second variable color display part 150 to reflect or transmit the light depending on the color of the second variable color display part 150.

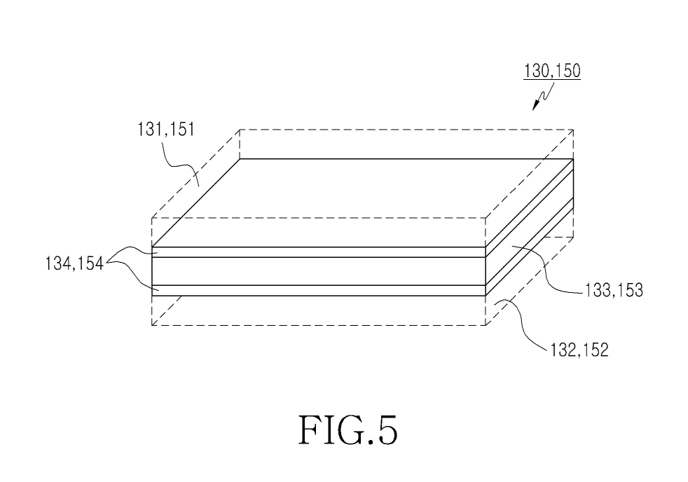

Referring to FIGS. 5 to 10, the key top part 110 is composed of a plurality of transparent color regions 111 and semi-transparent color regions 112 in black. The transparent color regions 111 are designed to display the first and second printed surfaces 141 and 161. The semi-transparent color regions 112 serve to distinguish the first and second printed surfaces 141 and 161 from a background surface in black.

The illuminating part 120 includes a Light Emitting Diode (LED) element (not shown) and a light transmitting plate (not shown).

The LED element is designed to irradiate light to the first and second variable color display parts 130 and 150 as well as the first and second base films 140 and 160.

The light transmitting plate is provided at a location adjacent to the LED element and formed with tiny irregularities (not shown) to diffuse the light introduced from the LED element. The upper surface of the light transmitting plate is provided with such tiny irregularities.

Meanwhile, the first and second variable color display parts 130 and 150 include upper and lower substrates 131, 151, 132 and 152, and liquid crystal layers 133 and 153.

The upper and lower substrates 131, 151, 132 and 152 are designed to display the color of the liquid crystal layers 133 and 153 and protect the same.

As shown in FIG. 5, the liquid crystal layers 133 and 153 are provided with three-color layers in red, green and blue, or with one-color layer in red, green or blue. Electrode layers 134 and 154 are provided on the upper and lower surfaces of the liquid crystal layers 133 and 153, respectively. In other words, the liquid crystal layers 133 and 153 are disposed between the upper substrates 131 and 151 and the lower substrates 132 and 152 so as to change the colors of the colored layers according to the electrical signal applied through the electrode layers 134 and 154.

The liquid crystal layers 133 and 153 may provide a variety of colors, such as a transparent, black, white color or the like, with combination of three-color layers in red, green and blue.

The first and second variable color display parts 130 and 150 are composed of cholesteric Liquid Crystal Displays (LCDs) 1 and 2, respectively, and may be constructed by another variable color display, for example, color filters, besides the cholesteric LCDs.

The first and second printed surfaces 141 and 161 are provided with a plurality of characters, numerals and symbols being printed thereon.

Referring back to FIG. 4, the illuminating part 120, the first and second variable color display parts 130 and 150, and the first and second base films 140 and 160 are joined together with an Optically Clear Adhesive (OCA) 180, but which may be attached to each other using a different adhesive, for example, a silicone adhesive, other than the OCA 180.

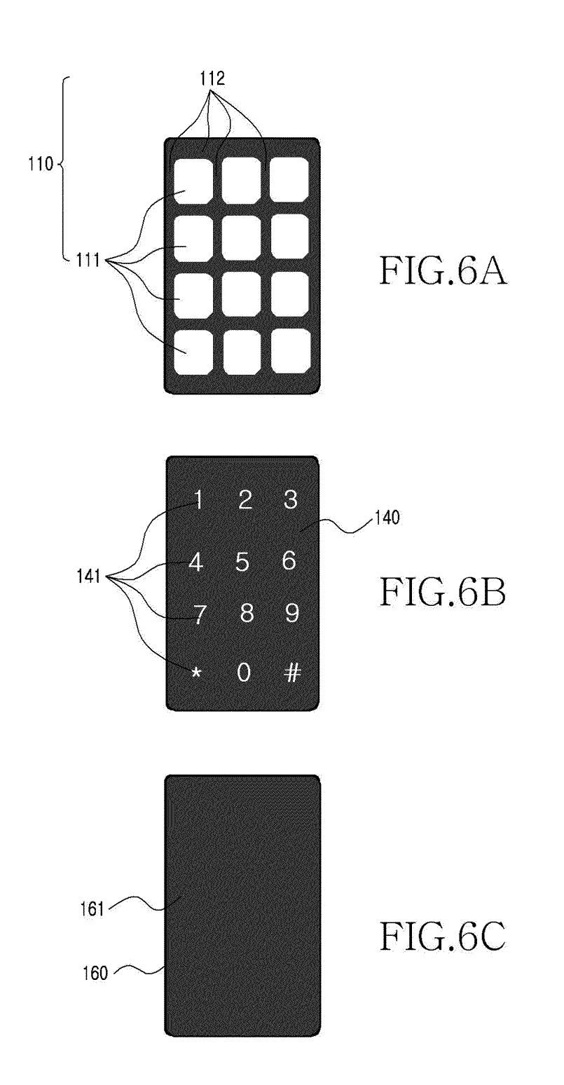

As shown in FIGS. 6a, 6b and 6c, the characters, numerals and symbols of the first printed surface 141 are formed in a transparent color, the background of the first base film 140 in black, and the background of the second base film 160 in blue (color not shown).

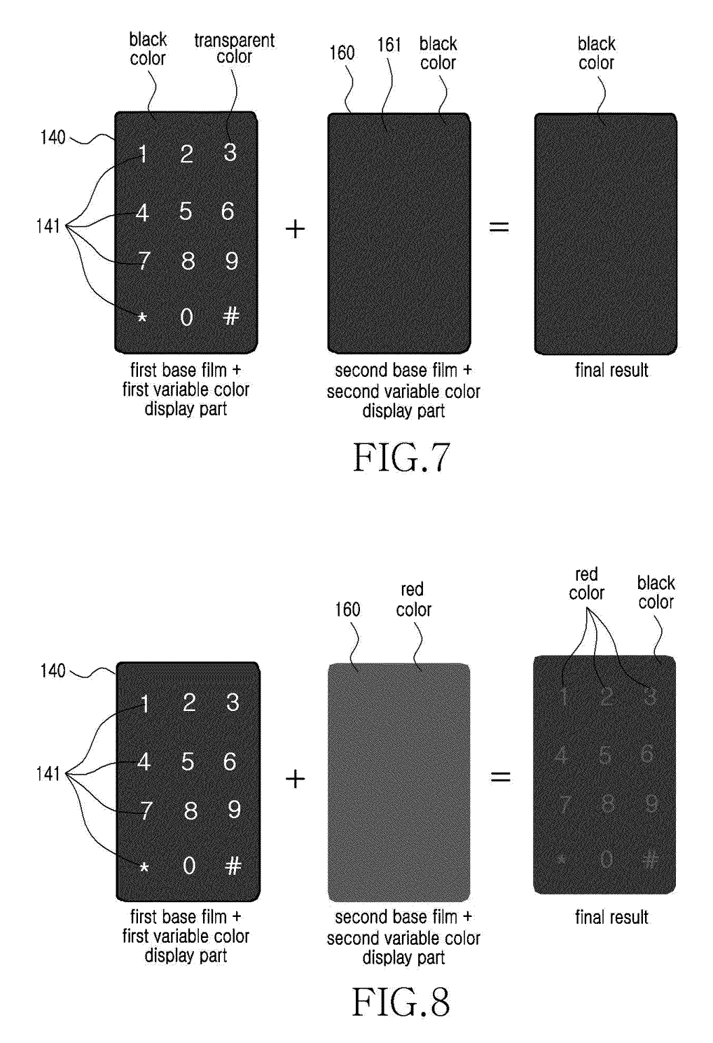

Referring to FIG. 7, when both the first and second variable color display parts 130 and 150 are driven in a transmission mode according to the electrical signal and transformed into a transparent color, the entire key top part 110 is displayed in black, and then the key top part 110 can be used as a touch pad.

Provided under the second base film 160 is a key Printed Circuit Board (PCB) 170 consisting of a plurality of dome switches (not shown) and a circuit (not shown) therefor.

The keypad apparatus in accordance with embodiments of the present invention described above includes a portable communication device (not shown) as an application. However, the portable communication device is not necessarily limited to a mobile communication terminal, it can be applied to terminals in various types, for example, a bar-type, a folder-type or a sliding-type terminal.

Portable communication devices in accordance with embodiments of the present invention may include all of the mobile communication terminals which are operated by communication protocols corresponding to various communication systems, all of the information communication devices, multimedia devices and application devices thereof including a Portable Multimedia Player (PMP), an MP3player, a navigation system, a game machine, a laptop computer, a signboard, TV, a digital broadcasting player, a Personal Digital Assistant (PDA), a smart phone or the like.

Operation of the keypad apparatus in accordance with a preferred first embodiment of the present invention with constructions as the above will be described herein with reference to FIGS. 4 to 10.

Referring to FIGS. 4 to 10, there is provided a keypad apparatus 100, including: a key top part 110 including a plurality of transparent color regions 111 to display first and second printed surfaces 141 and 161 and semi-transparent color regions 112 in black to bind the first and second printed surfaces 141 and 161, an illuminating part 120 or an FLU provided with a laminate under the key top part 110, a first variable color display part 130 provided with the laminate under the illuminating part 120, a first base film 140 provided with the laminate under the first variable color display part 130 and formed with the first printed surface 141 having a plurality of characters, numerals and symbols, a second variable color display part 150 provided with the laminate under the first base film 140, a second base film 160 provided with the laminate under the second variable color display part 150 and formed with the second printed surface 161, and a key printed circuit board provided with the laminate under the second base films 160.

As shown in FIG. 4, the illuminating part 120 and the first variable color display part 130 are joined together using OCA 180. Next, the first variable color display part 130 is attached to the first base film 140 with the OCA 180, and the first base film 140 is then joined with the second variable color display part 150 using the OCA 180.

Referring to FIGS. 6a, 6b and 6c, the characters, numerals and symbols on the first printed surface 141 of the first base film 140 are formed in a transparent color, the background of the first base film 140 in black, and the background of the second base film 160 in blue (color not shown).

In this state, as shown in FIG. 7, suppose that both the first and second variable color display parts 130 and 150 are driven in a transmission mode according to the electrical signal and transformed into a transparent color.

Then, the second variable color display part 150 enables the black color of the second base film 140 to be transmitted. The black color is delivered to the characters, numerals and symbols of the first base film 140 in a transparent color, which displays the entire first base film 140 in black.

Meanwhile, the first variable color display part 130 allows the blue color of the first base film 140 to be transmitted and the entire key top part 110 to be displayed in black.

In addition, when both the first and second variable color display parts 130 and 150 are driven in transmission modes according to the electrical signal and transformed into a transparent color, the entire key top part 110 is displayed in black. In this state, the key top part 110 can be used as a touch pad on which the characters, numerals and symbols can be inputted with a stylus pen (not shown).

As shown in FIG. 8, suppose that the first variable color display part 130 is driven in a transmission mode according to the electrical signal and transformed into a transparent color, while the second variable color display part 150 is driven in a reflection mode according to the electrical signal and transformed into a red color.

Then, the red color of the second variable color display part 150 is delivered and transmitted to the characters, numerals and symbols of the first base film 140 in a transparent color. Since the background of the first base film 140 is in black, only the characters, numerals and symbols of the first base film 140 are displayed in red by means of the red color of the second variable color display part 150.

As the first variable color display part 130 is in a transparent color, the red color of the second variable color display part 150 being transmitted allows the characters, numerals and symbols of the first base film 140 to be displayed in red through the transparent color region 111 of the key top part 110. Meanwhile, the remaining portion is displayed in black since the background color of the first base film 140 is displayed in black and overlaps with the black color of the semi-transparent region 112 of the key top part 110.

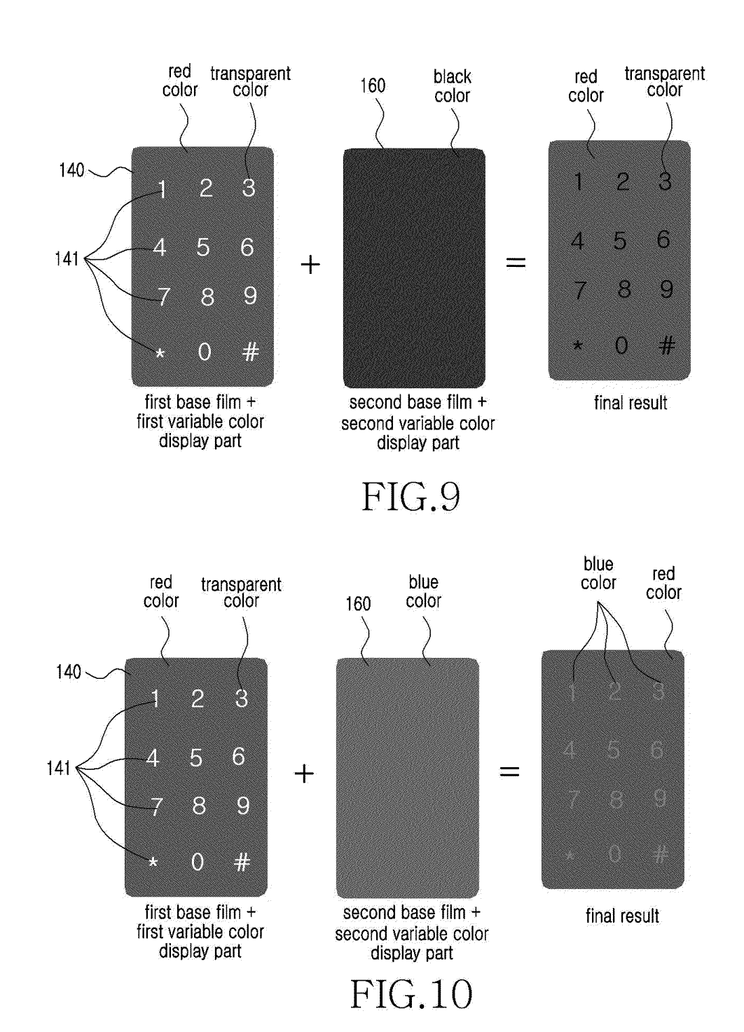

Referring to FIG. 9, suppose that the first variable color display part 130 is driven in a reflection mode according to the electrical signal and transformed into a red color, while the second variable color display part 150 is driven in a transmission mode according to the electrical signal and transformed into a transparent color.

Then, the transparent color of the second variable color display part 150 allows the black color of the second base film 160 to be transmitted, and the black color being transmitted is delivered and transmitted to the characters, numerals and symbols of the first base film 140.

The red color of the first variable color display part 130 enables the characters, numerals and symbols of the first base film 140 being transmitted in black to be displayed in black through the transparent color region 111 of the key top part 110. Meanwhile, the remaining background part except for the characters, numerals and symbols of the first base film 140 is displayed in red.

As shown in FIG. 10, suppose that the first variable color display part 130 is driven in a reflection mode according to the electrical signal and transformed into a red color, while the second variable color display part 150 is driven in a reflection mode according to the electrical signal and transformed into a blue color.

Then, the blue color of the second variable color display part 150 is delivered and transmitted to the characters, numerals and symbols of the first base film 140 in a transparent color to be displayed in blue.

The red color of the first variable color display part 130 enables the characters, numerals and symbols of the first base film 140 being transmitted in blue to be displayed in blue through the transparent color region 111 of the key top part 110. Meanwhile, the remaining background part except for the characters, numerals and symbols of the first base film 140 is displayed in red.

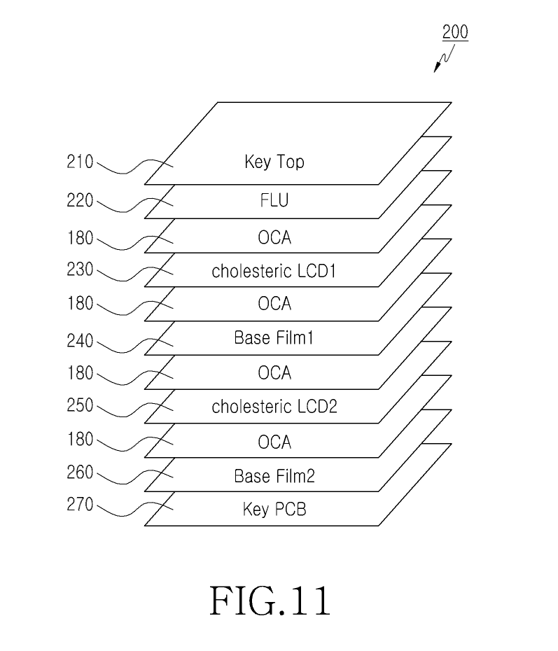

Operation of a keypad apparatus 200 in accordance with a preferred second embodiment of the present invention will be described herein with reference to FIGS. 11 to 16.

Referring to FIGS. 11 to 16, there is provided a keypad apparatus 200, including: a key top part 210 consisting of a first printed surface 211 a to be displayed upon selection and a transparent color regions 211b, an illuminating part 220 or FLU provided with a laminate under the key top part 210 for introducing the light of a light emitting element (not shown) and diffusing the same, a first variable color display part 230 to be irradiated by the diffused light from the illuminating part 220 for selectively transforming its color to be reflected or transmitted according to an electrical signal, a first base film 240 provided with the laminate under the first variable color display part 230 and formed with a second printed surface 241 to be displayed upon selection, a second variable color display part 250 to be irradiated by the diffused light from the illuminating part 220 for selectively transforming its color to be reflected or transmitted according to the electrical signal, and a second base film 260 provided with the laminate under the second variable color display part 250 and formed with a third printed surface 261 to be displayed upon selection.

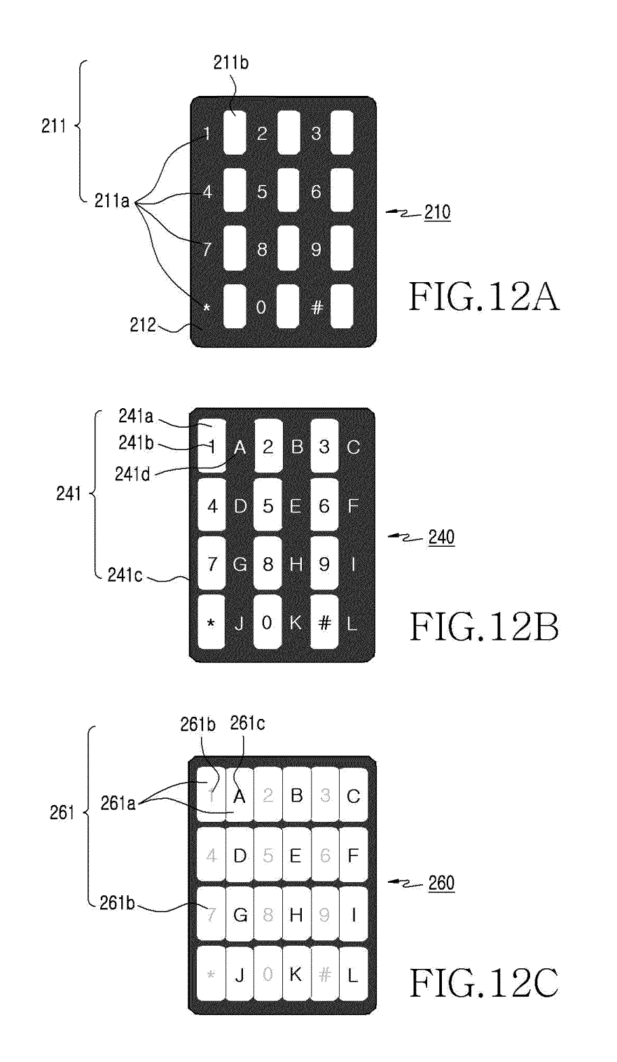

As shown in FIG. 12a, a plurality of numerals 211 a in a transparent color are formed on the first printed surface 211, and a plurality of transparent regions 211b are formed at locations adjacent to the plurality of numerals 211a. The remaining portions 212 of the key top part 210 except for the numerals 211a and the transparent regions 211b are formed in black.

Referring to FIG. 12b, the second printed surface 241 is formed with a plurality of white regions 241a. Formed within the white regions 241a are a plurality of numerals 241b in black. At the locations near the white regions 241a, a plurality of characters and symbols 241 d in a transparent color are formed on the background 241c in black.

As shown in FIG. 12c, a plurality of numerals 261b in a transparent color are formed at the background 261a in white on the third printed surface 261, and a plurality of characters and symbols 261 c in black are formed on the background 261a in white at the locations adjacent to the numerals 261b.

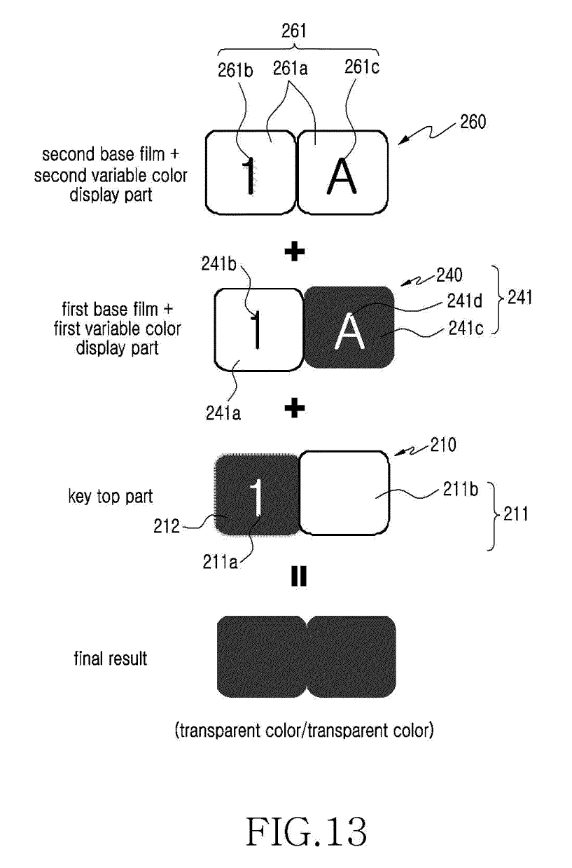

In this state, as shown in FIG. 13, suppose that both the first and second variable color display parts 230 and 250 are driven in transmission modes according to the electrical signal and transformed into a transparent color.

Then, the transparent color of the second variable color display part 250 allows the numerals 261b of the second base film 260 to be displayed in a transparent color and the characters and symbols 261c displayed in black to be transmitted, and also delivers the numerals 261b in a transparent color and the characters and symbols 261c in black to the first base film 240.

At this point, the transparent color of the first variable color display part 230 enables the numerals 241b of the first base film 240 in black to be transmitted and projected onto the numerals 211a of the key top part 210 in a transparent color, which displays the numerals 241b in black, and the background of the key top part 210 is also in black. Here, since both the numerals 211 a of the key top part 210 and its background are in black, the entire key top part 210 is displayed in black. Further, the characters and symbols 261c of the second base film 260 in black are transmitted through the characters and symbols 241 d of the first base film 240 in a transparent color to be displayed in black. Since the background 241c of the first base film 240 is in black, the black-colored characters and symbols 261c of the second base film 260 are overlapped with the black-colored background 241c of the first base film 240 to be displayed in black. Hence, the entire key top part 210 is displayed in black through the transparent region 211b of the key top part 210.

When both the first and second variable color display parts 230 and 250 are driven in transmission modes according to the electrical signal and transformed into a transparent color, all the characters, numerals and symbols of the key top part 210 are shown in black. In this state, the key top part 210 can be used as a touch pad on which the characters, numerals and symbols can be inputted using the stylus pen (not shown).

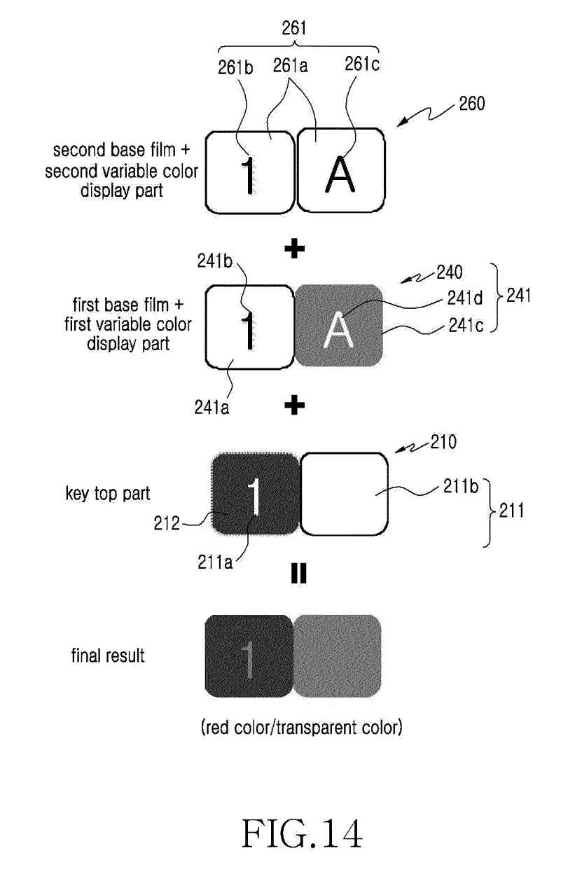

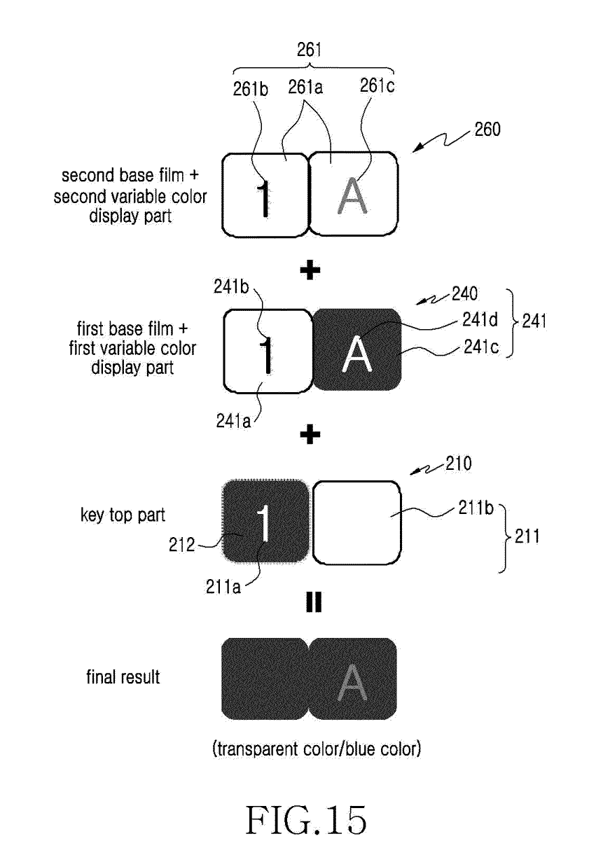

As shown in FIG. 14, suppose that the first variable color display part 230 is driven in a reflection mode according to the electrical signal and transformed into a red color, while the second variable color display part 250 is driven in a transmission mode according to the electrical signal and transformed into a transparent color.

Then, the transparent color of the second variable color display part 250 allows the numerals 261b of the second base film 260 to be displayed in a transparent color and the black-colored characters and symbols 261c to be transmitted, and also delivers the numerals 261b in a transparent color and black-colored the characters and symbols 261c to the first base film 240.

The red color of the first variable color display part 230 allows the black-colored numerals 241b of the first base film 240 to be displayed in red, and the numerals 241b in red are projected onto the numerals 211a of the key top part 210 in a transparent color to be displayed in red on the background of the key top part 210 in black. Further, the transmitted characters and symbols 261c of the second base film 260 in black are transmitted through the characters and symbols 241d of the first base film 240 in a transparent color to be displayed in black. Since the remaining background 241c of the characters and symbols 241d of first base film 240 is in black, the characters and symbols 241d and the entire remaining portion of the first base film 240 are displayed in black, while an entire part is displayed in red by means of the red color of the first variable color display part 230. Therefore, the characters and symbols are not seen by the transparent region 211b of the key top part 21, displaying only the red color.

Referring to FIG. 15, suppose that the first variable color display part 230 is driven in a transmission mode according to the electrical signal and transformed into a transparent color, while the second variable color display part 250 is driven in a reflection mode according to the electrical signal and transformed into a blue color.

Then, the blue color of the second variable color display part 250 allows the black-colored characters and symbols 261c of the first base film 240 to be displayed in blue and the numerals 261b in a transparent color to be transmitted.

The transparent color of the first variable color display part 230 enables the black-colored numerals 241b of the first base film 240 to be transmitted and projected onto the numerals 211a of the key top part 210 in a transparent color and the numerals of the key top part to be displayed in black. Since the background of the key top part 210 except the numeral 211a is in black, the entire key top part 210 is displayed in black. Meanwhile, the blue-colored characters and symbols 261c of the second base film 260 are transmitted through the characters and symbols 241d of the first base film 240 in a transparent color to be displayed in blue on the background of the first base film 240 in black. At this moment, the blue-colored characters and symbols 261c are transmitted through the transparent region 211b of the key top part 210 and displayed in blue on the black-colored background.

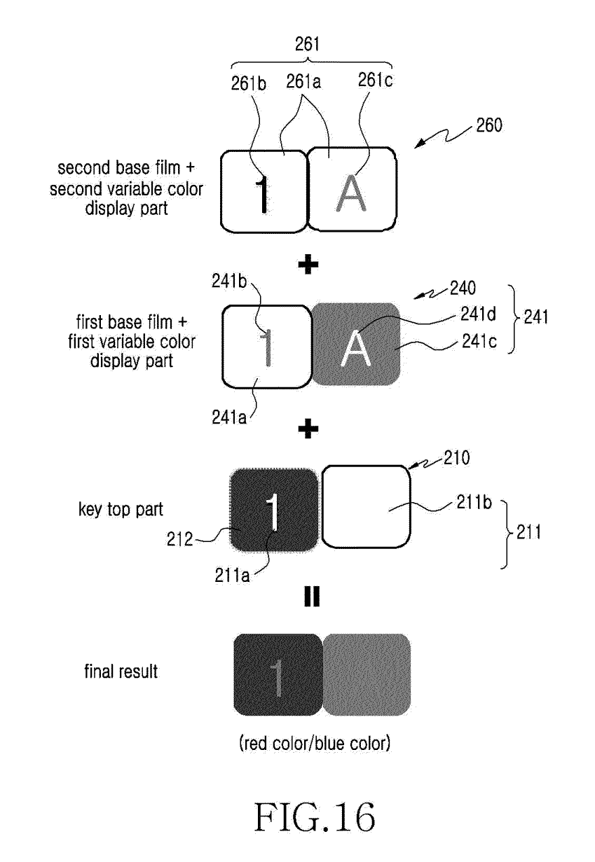

As shown in FIG. 16, suppose that the first variable color display part 230 is driven in a reflection mode according to the electrical signal and transformed into a red color, while the second variable color display part 250 is driven in a reflection mode according to the electrical signal and transformed into a blue color.

Then, the blue color of the second variable color display part 250 allows the numerals 261b of the second base film 260 to be displayed in a transparent color and transmitted and the black-colored characters and symbols 261c of the second base film 260 to be transformed into a blue color.

The red color of the first variable color display part 230 enables the black-colored numerals 241b of the first base film 240 to be displayed in red, and the numerals 241b in red are transmitted through the numerals 211a of the key top part 210 in a transparent color to be displayed in red on the black-colored background. Meanwhile, the blue-colored characters and symbols 261c of the second base film 260 are transmitted through the characters and symbols 241d of the first base film 240 in a transparent color. The background of the first base film 240 in black is displayed in a red color, and the characters and symbols 261c are then displayed in blue on the red-colored background through the transparent region 211b of the key top part 210.

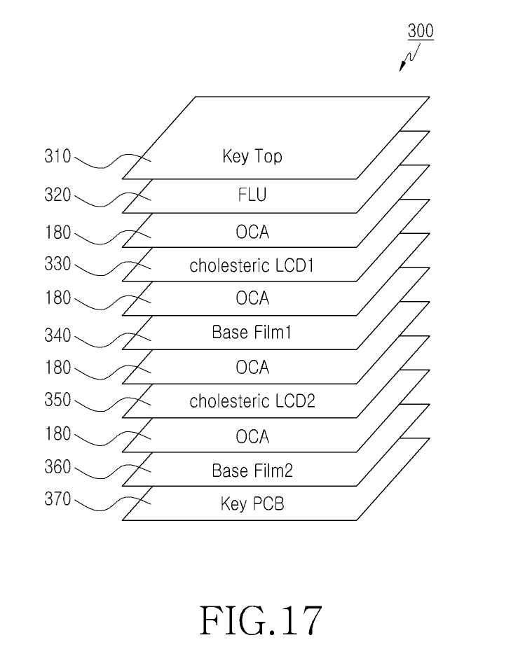

Operation of a keypad apparatus 300 in accordance with a preferred third embodiment of the present invention will be described herein with reference to FIGS. 17 to 22.

Referring to FIGS. 17 to 22, there is provided a keypad apparatus 300, including: the key top part 210 provided with a first printed surface 311a which is formed in a transparent color on a background 312 in black, an illuminating part 320 or FLU provided with a laminate under the key top part 310 for introducing the light of a light emitting element (not shown) and diffusing the same, a first variable color display part 330 to be irradiated by the diffused light from the illuminating part 320 for selectively transforming its color to be reflected or transmitted according to an electrical signal, a first base film 340 provided with the laminate under the first variable color display part 330 and formed with a second printed surface 341a to be displayed in black on the background 312 in a transparent color on which the first and third printed surfaces 311a and 361a are overlappingly provided, a second variable color display part 350 provided with the laminate under first base film 340 and irradiated by the diffused light from the illuminating part 320 for selectively transforming its color to be reflected or transmitted according to the electrical signal, and a second base film 360 provided with the laminate under the second variable color display part 350 and formed with a third printed surface 361a to be displayed in black on the background 312 in white on which the first and second printed surfaces 311a and 341a are overlappingly provided.

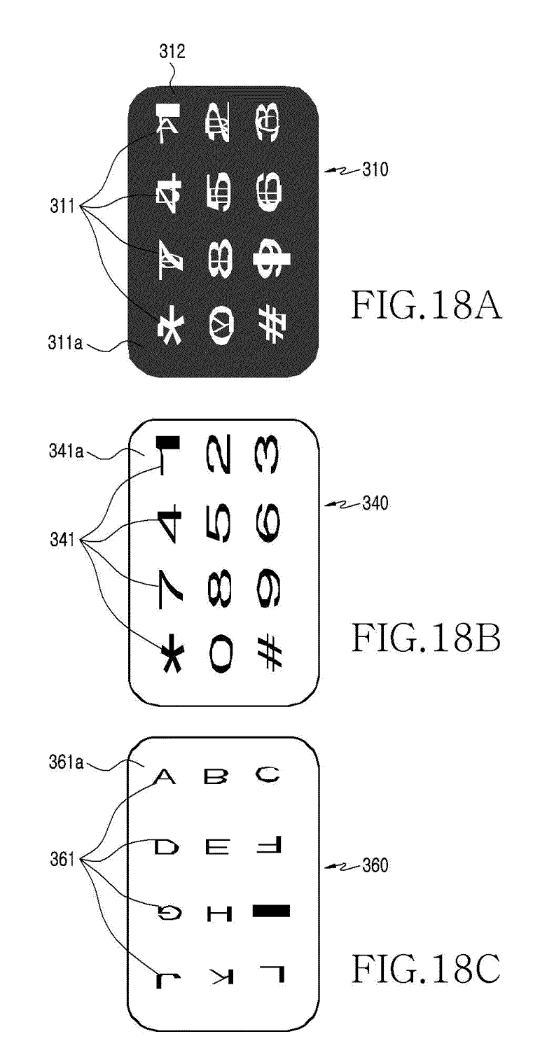

Referring to FIGS. 18a, 18b and 18c, a plurality of characters, numerals and symbols 311 are formed on the first printed surface 311a, a plurality of numerals and symbols 341 on the second printed surface 341a, and a plurality of characters 361 on the third printed surface 361a.

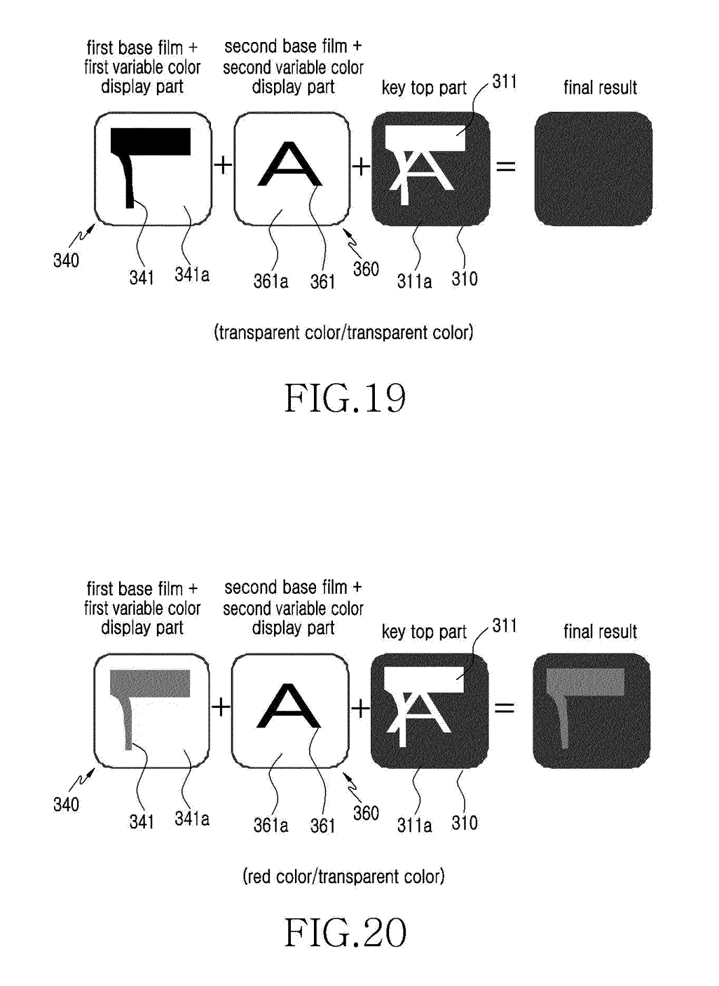

In this state, as shown in FIG. 19, suppose that both the first and second variable color display parts 330 and 350 are driven in transmission modes according to the electrical signal and transformed into a transparent color.

Then, the transparent color of the second variable color display part 350 allows the numerals 361 of the second base film 360 in black to be transmitted and the black-colored characters and symbols 341 to be delivered to the first base film 340. The transparent color of the first variable color display part 330 enables the black-colored numerals 361 as well as the numerals and symbols 341 of the first base film 340 to be transmitted. Therefore, the black-colored characters, numerals and symbols of the first and second base films are projected onto the characters, numerals and symbols formed in a transparent color on the key top part 310 to be displayed in black, and then the entire key top part 310 with the black-colored background is displayed in black.

Meanwhile, when both the first and second variable color display parts 330 and 350 are driven in transmission modes according to the electrical signal and transformed into a transparent color, all the characters, numerals and symbols of the key top part 310 are displayed in black. In this state, the key top part 310 can be used as a touch pad on which the characters, numerals and symbols can be inputted using the stylus pen (not shown).

As shown in FIG. 20, suppose that the first variable color display part 330 is driven in a reflection mode according to the electrical signal and transformed into a red color, while the second variable color display part 350 is driven in a transmission mode according to the electrical signal and transformed into a transparent color.

Then, the transparent color of the second variable color display part 350 allows the characters 361 of the second base film 360 in black to be transmitted, and also the black-colored characters 361 to be delivered to the first base film 240 and projected onto the characters of the key top part 310 in a transparent color, which are displayed in black like the black-colored background 312 of the key top part 310.

The red color of the first variable color display part 330 enables the black-colored numerals and symbols 341 of the first base film 340 to be displayed in red, the red-colored numerals and symbols 341 are transmitted through the numerals and symbols of the key top part 310 in a transparent color to be displayed in red on the black-colored background 312, and the remaining characters in black are not displayed.

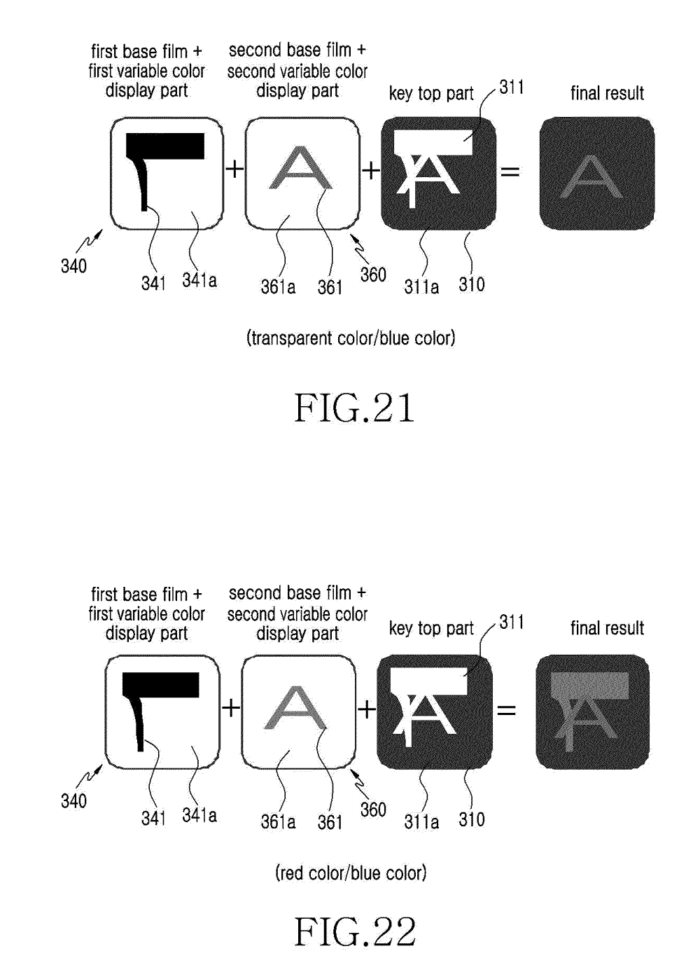

Referring to FIG. 21, suppose that the first variable color display part 330 is driven in a transmission mode according to the electrical signal and transformed into a transparent color, while the second variable color display part 350 is driven in a reflection mode according to the electrical signal and transformed into a blue color.

Then, the blue color of the second variable color display part 350 allows the characters 361 of the second base film 360 formed in black to be displayed in blue.

The transparent color of the first variable color display part 330 enables the blue-colored characters of the second base film 360 as well as the numerals and symbols 341 of the first base film 340 in black to be transmitted. Meanwhile, the key top part 310 with the black-colored background 312 allows the black-colored numerals and symbols 341 of the first base film 340 to be transmitted and displayed in black like the background 312. Therefore, the blue-colored characters of the second base film 360 are transmitted to be displayed in blue on the black-colored background 312.

As shown in FIG. 22, suppose that the first variable color display part 330 is driven in a reflection mode according to the electrical signal and transformed into a red color, while the second variable color display part 350 is driven in a reflection mode according to the electrical signal and transformed into a blue color.

Then, the blue color of the second variable color display part 350 allows the black-colored characters 361 of the second base film 360 to be displayed in blue.

The red color of the first variable color display part 330 enables the blue-colored characters of the second base film 360 to be transmitted and the black-colored numerals and symbols 341 of the first base film 340 to be displayed in red. Meanwhile, the blue-colored characters are transmitted through the characters of the key top part 310 in a transparent color and displayed in blue on the black-colored background 312. Therefore, the red-colored characters and symbols are transmitted through the numerals and symbols of the key top part 310 in a transparent color and displayed in red on the black-colored background 312.

While the invention has been shown and described with reference to certain embodiments thereof, it will be understood by those skilled in the art that various changes in form and details may be made therein without departing from the spirit and scope of the invention as defined by the appended claims.

What is claimed is:

1. A key pad apparatus comprising:
a key top part;
an illuminating part for introducing light of a light emitting element and diffusing the light;
a first variable color display part to be irradiated by the diffused light from the illuminating part for selectively transforming its color to be reflected or transmitted according to an electrical signal;
a first base film provided with a laminate under the first variable color display part and formed with a first printed surface;
a second variable color display part provided with the laminate under the first base film to be irradiated by the diffused light from the illuminating part for selectively transforming its color to be reflected or transmitted according to the electrical signal; and
a second base film provided with the laminate under the second variable color display part and formed with a second printed surface.

2. The key pad apparatus as recited in claim 1, wherein the key top part includes a plurality of transparent color regions to display the first and second printed surfaces and semi-transparent color regions in black to distinguish the first and second printed surfaces.

3. The key pad apparatus as recited in claim 1, wherein the illuminating part includes a Light Emitting Diode (LED) element and a light transmitting plate formed with irregularities on its upper surface to diffuse the light introduced from the LED element.

4. The key pad apparatus as recited in claim 1, wherein the first and second variable color display parts include upper and lower substrates and liquid crystal layers provided between the upper and lower substrates, wherein the liquid crystal layers are provided with three-color layers in red, green and blue, or with one-color layer in red, green or blue, wherein electrode layers are provided on upper and lower surfaces of the liquid crystal layers, and wherein the color of the colored layers is changed according to the electrical signal applied through the electrode layers.

5. The key pad apparatus as recited in claim 1, wherein the first and second variable color display parts are composed of cholesteric liquid crystal displays.

6. The key pad apparatus as recited in claim 1, wherein the first and second printed surfaces are provided with a plurality of characters, numerals and symbols printed thereon.

7. The key pad apparatus as recited in claim 1, wherein the illuminating part, the first and second variable color display parts, and the first and second base films are joined together with an optically clear adhesive.

8. The key pad apparatus as recited in claim 1, wherein a plurality of characters, numerals and symbols of the first printed surface of the first base film are formed in a transparent color, a background of the first base film in black, and a background of the second base film in blue.

9. The key pad apparatus as recited in claim 8, wherein when the first and second variable color display parts are driven in transmission modes according to the electrical signal and transformed into the transparent color, the second variable color display part enables the black color of the second base film to be transmitted, and the black color is transmitted to the characters, numerals and symbols of the first base film in the transparent color to display the entire first base film in black;
wherein the first variable color display part allows the black color of the first base film to be transmitted and the entire key top part to be displayed in black;
wherein when the first variable color display part is driven in the transmission mode according to the electrical signal and transformed into the transparent color, while the second variable color display part is driven in a reflection mode according to the electrical signal and transformed into a red color, the red color of the second variable color display part is delivered and transmitted to the characters, numerals and symbols of the first base film in the transparent color, and since the background of the first base film is in black, only the characters, numerals and symbols of the first base film are displayed in red by means of the red color of the second variable color display part; and
wherein the transparent color of the first variable color display part allows the transmitted characters, numerals and symbols of the first base film in red to be displayed in red through a transparent color region of the key top part, and the remaining portion is displayed in black since the black-colored background of the first base film is overlapped with the black color of a semi-transparent region of the key top part.

10. The key pad apparatus as recited in claim 8, wherein when the first variable color display part is driven in a reflection mode according to the electrical signal and transformed into a red color, while the second variable color display part is driven in a transmission mode according to the electrical signal and transformed into a transparent color, the transparent color of the second variable color display part allows the entire black color of the second base film to be transmitted, and the transmitted black color is delivered and transmitted to the characters, numerals and symbols of the first base film;
wherein the red color of the first variable color display part enables the transmitted black-colored characters, numerals and symbols of the first base film to be displayed in black through a transparent color region of the key top part, and the remaining background part except the characters, numerals and symbols of the first base film is displayed in red;
wherein the first variable color display part is driven in a reflection mode according to the electrical signal and transformed into a red color, while the second variable color display part is driven in a reflection mode according to the electrical signal and transformed into a blue color, the blue color of the second variable color display part is delivered and transmitted to the characters, numerals and symbols of the first base film in a transparent color to be displayed in blue; and
wherein the red color of the first variable color display part enables the transmitted blue-colored characters, numerals and symbols of the first base film to be displayed in blue through the transparent color region of the key top part, and the remaining background part except the characters, numerals and symbols of the first base film is displayed in red.

11. The key pad apparatus as recited in claim 9, wherein when the first and second variable color display parts are driven in the transmission modes according to the electrical signal and transformed into the transparent color, the entire key top part is displayed in black and the key top part can be used as a touch pad.

12. A key pad apparatus comprising:
a key top part provided with a first printed surface to be displayed upon selection and a transparent color region;
an illuminating part provided with a laminate under the key top part for introducing light of a light emitting element and diffusing the light;
a first variable color display part to be irradiated by the diffused light from the illuminating part for selectively transforming its color to be reflected or transmitted according to an electrical signal;
a first base film provided with the laminate under the first variable color display part and formed with a second printed surface to be displayed upon selection;
a second variable color display part provided with the laminate under the first base film to be irradiated by the diffused light from the illuminating part for selectively transforming its color to be reflected or transmitted according to the electrical signal; and
a second base film provided under the second variable color display part and formed with a third printed surface to be displayed upon selection.

13. The key pad apparatus as recited in claim 12, wherein a plurality of numerals in the transparent color are formed on the first printed surface, and a plurality of transparent regions are formed at locations adjacent to the plurality of numerals, and wherein the remaining portion of the key top part except for the numerals and the transparent regions is formed in black.

14. The key pad apparatus as recited in claim 13, wherein a plurality of white regions are formed on the second printed surface, and the plurality of numerals are printed in black within the white regions; and
wherein a plurality of characters and symbols in the transparent color are printed on a black-colored background at the locations adjacent to the white regions.

15. The key pad apparatus as recited in claim 14, wherein the plurality of numerals in the transparent color are formed at a white-colored background on the third printed surface, and the plurality of characters and symbols in black are printed on the white-colored background at the locations adjacent to the numerals.

16. The key pad apparatus as recited in claim 15, wherein when both the first and second variable color display parts are driven in transmission modes according to the electrical signal and transformed into the transparent color, the transparent color of the second variable color display part allows the numerals of the second base film in the transparent color and black-colored characters and symbols to be transmitted, and also deliver the numerals in the transparent color and the black-colored characters and symbols to the first base film;
wherein, the transparent color of the first variable color display part enables the black-colored numerals of the first base film to be transmitted and projected onto the numerals of the key top part in the transparent color to be displayed in black, and the background of the key top part is in black, wherein since both the numerals of the key top part and its background are in black, the entire key top part is displayed in black, wherein the black colored characters and symbols of the second base film are transmitted through the characters and symbols of the first base film in the transparent color to be displayed in black, wherein since the background of the first base film is in black, the black colored characters and symbols of the second base film are overlapped with the black colored background of the first base film to be displayed in black, and wherein the entire key top part is displayed in black through the transparent region of the key top part ;
wherein when the first variable color display part is driven in a reflection mode according to the electrical signal and transformed into a red color, while the second variable color display part is driven in the transmission mode according to the electrical signal and transformed into the transparent color, the transparent color of the second variable color display part allows the numerals of the second base film in the transparent color and the black colored the characters and symbols to be transmitted, and also delivers the numerals in the transparent color and the black colored characters and symbols to the first base film;
wherein the red color of the first variable color display part allows the black colored numerals of the first base film to be displayed in red, and the red-colored numerals are transmitted through the numerals of the key top part in the transparent color to be displayed in red on the black-colored background of the key top part, wherein the transmitted black-colored characters and symbols of the second base film are transmitted through the characters and symbols of the first base film in the transparent color to be displayed in black, wherein since the remaining background of the characters and symbols of the first base film is in black, the characters and symbols and the entire remaining portion of the first base film are displayed in black, and an entire part thereof is displayed in red by the red color of the first variable color display part, and wherein the characters and symbols are not displayed by the transparent region of the key top part, displaying only the red color.

17. The key pad apparatus as recited in claim 15, wherein the first variable color display part is driven in a transmission mode according to the electrical signal and transformed into the transparent color, while the second variable color display part is driven in a reflection mode according to the electrical signal and transformed into a blue color, the blue color of the second variable color display part allows black-colored characters and symbols of the first base film to be displayed in blue and the numerals in the transparent color to be transmitted;
wherein the transparent color of the first variable color display part enables the black-colored numerals of the first base film to be transmitted and projected onto the numerals of the key top part in the transparent color and the numerals of the key top part to be displayed in black, wherein since the background of the key top part except the numerals is in black, the entire key top part is displayed in black, wherein the blue-colored characters and symbols of the second base film are transmitted through the characters and symbols of the first base film in the transparent color to be displayed in blue on the black-colored background of the first base film, and wherein the blue-colored characters and symbols are transmitted through the transparent region of the key top part and displayed in blue with the background in black;
wherein when the first variable color display part is driven in the reflection mode according to the electrical signal and transformed into a red color, while the second variable color display part is driven in the reflection mode according to the electrical signal and transformed into the blue color, the blue color of the second variable color display part allows the numerals of the second base film in the transparent color to be transmitted and the black-colored characters and symbols of the second base film to be transformed into a blue color; and
wherein the red color of the first variable color display part allows the black-colored numerals of the first base film to be displayed in red, and the red-colored numerals are transmitted through the numerals of the key top part in the transparent color to be displayed in red on the black-colored background, wherein the blue-colored characters and symbols of the second base film are transmitted through the characters and symbols of the first base film in the transparent color, wherein the black-colored background of the first base film is displayed in the red color, and wherein the characters and symbols are displayed in blue on the red-colored background through the transparent region of the key top part.

18. The key pad apparatus as recited in claim 16, wherein when both the first and second variable color display parts are driven in the transmission modes according to the electrical signal and transformed into the transparent color, the entire key top part is displayed in black, and the key top part can be used as a touch pad.

19. A keypad apparatus comprising:
a key top part provided with a first printed surface which is formed in a transparent color with a background in black;
an illuminating part provided with a laminate under the key top part for introducing light of a light emitting element and diffusing the light;
a first variable color display part to be irradiated by the diffused light from the illuminating part for selectively transforming its color to be reflected or transmitted according to an electrical signal;
a first base film provided with the laminate under the first variable color display part and formed with a second printed surface in black with a background in the transparent color which is overlappingly provided with the first printed surface and a third printed surface;
a second variable color display part provided with the laminate under the first base film to be irradiated by the diffused light from the illuminating part for selectively transforming its color to be reflected or transmitted according to the electrical signal; and
a second base film provided with the laminate under the second variable color display part and formed with the third printed surface in black with a background in white which is overlappingly provided with the first and second printed surfaces.

20. The key pad apparatus as recited in claim 19, wherein a plurality of characters, numerals and symbols are formed on the first printed surface, a plurality of numerals and symbols are formed on the second printed surface, and a plurality of characters are formed on the third printed surface.

21. The key pad apparatus as recited in claim 20, wherein when both the first and second variable color display parts are driven in transmission modes according to the electrical signal and transformed into a transparent color, the transparent color of the second variable color display part allows black-colored numerals of the second base film to be transmitted and black-colored characters to be delivered to the first base film,
wherein the transparent color of the first variable color display part enables the black-colored characters to be transmitted and black-colored numerals and symbols of the first base film to be transmitted, wherein the black-colored characters, numerals and symbols of the first and second base films are projected onto the characters, numerals and symbols formed on the key top part in the transparent color to be displayed in black, and wherein the entire key top part with the black-colored background is displayed in black;
wherein when the first variable color display part is driven in a reflection mode according to the electrical signal and transformed into a red color, while the second variable color display part is driven in a transmission mode according to the electrical signal and transformed into the transparent color, the transparent color of the second variable color display part allows the black-colored characters of the second base film to be transmitted, and the black-colored characters to be delivered to the first base film and projected the same onto the characters of the key top part in the transparent color to be displayed in black like the black-colored background of the key top part; and
wherein the red color of the first variable color display part enables the black-colored numerals and symbols of the first base film to be displayed in red, the red-colored numerals and symbols are transmitted through the numerals and symbols of the key top part in the transparent color to be displayed in red on the black-colored background, and the remaining black-colored characters are not displayed.

22. The key pad apparatus as recited in claim 20, wherein when the first variable color display part is driven in a transmission mode according to the electrical signal and transformed into the transparent color, while the second variable color display part is driven in a reflection mode according to the electrical signal and transformed into a blue color, the blue color of the second variable color display part allows the black-colored characters of the second base film to be displayed in blue;
wherein the transparent color of the first variable color display part enables the blue-colored characters of the second base film to be transmitted and the black-colored numerals and symbols of the first base film to be transmitted, wherein the key top part with the black-colored background allows the black-colored numerals and symbols of the first base film to be transmitted and displayed in black like the black-colored background, and wherein the blue-colored characters of the second base film are transmitted to be displayed in blue on the blue-colored background;
wherein the first variable color display part is driven in a reflection mode according to the electrical signal and transformed into a red color, while the second variable color display part is driven in the reflection mode according to the electrical signal and transformed into a blue color, the blue color of the second variable color display part enables the black-colored characters of the second base film to be displayed in blue; and
wherein the red color of the first variable color display part allows the blue-colored characters of the second base film to be transmitted and the black-colored numerals and symbols of the first base film to be displayed in red, wherein the blue-colored characters are transmitted through the characters of the key top part in the transparent color and displayed in blue on the black-colored background, and wherein the red-colored characters and symbols are transmitted through the numerals and symbols of the key top part in the transparent color and displayed in red on the black-colored background.

23. The key pad apparatus as recited in claim 21, wherein when both the first and second variable color display parts are driven in the transmission modes according to the electrical signal and transformed into the transparent color, the entire key top part is displayed in black, and the key top part can be used as a touch pad.
